(19) United States
(12) Patent Application Publication
(10) Pub. No.: US 2007/0133031 A1
(43) Pub. Date: Jun. 14, 2007

(54) IMAGE PROCESSING APPARATUS AND IMAGE PROCESSING METHOD

(75) Inventors: Yoichi Takaragi, Tokyo (JP); Shinichi Fukada, Tokyo (JP); Tsutomu Murayama, Tokyo (JP); Kunio Yoshihara, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/567,049

(22) Filed: Dec. 5, 2006

(30) Foreign Application Priority Data
Dec. 8, 2005 (JP) 2005-355138

(51) Int. Cl. G06F 3/12

(52) U.S. Cl. 358/1.13; 345/538

(57) ABSTRACT

An image processing apparatus includes a receiving unit configured to externally receive print data including information on an attribute of an image to print, a rasterizing unit configured to generate raster image data based on the print data received by the receiving unit, an attribute data generating unit configured to generate attribute data representing an attribute of an image included in the raster image data generated by the rasterizing unit based on the information on an attribute of an image to print included in the print data, and a vectorizing unit configured to vectorize at least a part of the raster image data. The vectorizing unit identifies the attribute of the image included in the raster image data based on the attribute data generated by the attribute data generating unit, and performs vectorization based on the identified attribute of the image.

### BACKGROUND OF THE INVENTION

1. Field of the Invention

The present invention relates to an image processing apparatus and to an image processing method.

2. Description of the Related Art

Print data received by image processing apparatuses, such as a printer or a digital multifunction peripheral, from personal computers can be stored in a storage device, such as a hard disk, by being recorded thereon. Consequently, reprinting can be performed according to the print data stored in the storage device, without receiving print data from the personal computer again. Raster image data, which is obtained by rasterizing print data, is often stored in storage devices in order to enable quick reprinting.

Meanwhile, raster image data read by a scanner is vectorized by performing outline vectorization processing, as disclosed in Japanese Patent Application Laid-Open No. 2005-107691. This enables reutilization of the image data in editing by application software.

However, to perform vectorization, it is necessary to separate the raster image data into image areas, such as a text area, a picture area, and a graphic area. Image area separation processing disclosed in Japanese Patent Application Laid-Open No. 2005-107691 may erroneously determine an image area according to some original image data. Thus, sometimes, highly accurate vectorization of image data cannot be achieved.

### SUMMARY OF THE INVENTION

The present invention is directed to technology for performing higher precision vectorization on image data stored according to print data received by an image processing apparatus.

According to an aspect of the present invention, an image processing apparatus includes a receiving unit configured to externally receive print data including information on an attribute of an image to print, a rasterizing unit configured to generate raster image data based on the print data received by the receiving unit, an attribute data generating unit configured to generate attribute data representing an attribute of an image included in the raster image data generated by the rasterizing unit based on the information on an attribute of an image to print included in the print data, and a vectorizing unit configured to vectorize at least a part of the raster image data. The vectorizing unit identifies the attribute of the image included in the raster image data based on the attribute data generated by the attribute data generating unit, and performs vectorization based on the identified attribute of the image.

According to another aspect of the present invention, an image processing apparatus includes a receiving unit configured to externally receive print data including information on an attribute of an image to print, a rasterizing unit configured to generate raster image data based on the print data received by the receiving unit, an attribute data generating unit configured to generate attribute data representing an attribute of an image included in the raster image data generated by the rasterizing unit based on the information on an attribute of an image to print included in the print data, a vectorizing unit configured to vectorize at least a part of the raster image data, and an area determining unit configured to determine an area to be vectorized by the vectorizing unit in the raster image data according to an instruction from a user. The vectorizing unit identifies the attribute of the image in the area determined by the area determining unit based on the attribute data generated by the attribute data generating unit, and performs vectorization on the area in the raster image data based on the identified attribute of the image.

According to another aspect of the present invention, an image processing apparatus includes a receiving unit configured to externally receive print data, a rasterizing unit configured to generate raster image data based on the print data received by the receiving unit, an attribute data generating unit configured to generate attribute data representing an attribute of an image included in the raster image data, and a vectorizing unit configured to vectorize at least a part of the raster image data. The vectorizing unit identifies the attribute of the image included in the raster image data based on the attribute data generated by the attribute data generating unit, and performs vectorization processing based on the identified attribute of the image.

According to yet another aspect of the present invention, an image processing method includes externally receiving print data including information on an attribute of an image to print, generating raster image data based on the received print data, generating attribute data representing an attribute of an image included in the generated raster image data based on the information on an attribute of an image to print included in the print data, and vectorizing at least a part of the raster image data. The vectorizing includes identifying the attribute of the image included in the raster image data based on the generated attribute data, and performing vectorization based on the identified attribute of the image.

According to still another aspect of the present invention, an image processing method includes externally receiving print data including information on an attribute of an image to print, generating raster image data based on the received print data, generating attribute data representing the attribute of the image included in the generated raster image data based on the information on an attribute of an image to print included in the print data, vectorizing at least a part of the raster image data, and determining an area to be vectorized in the raster image data according to an instruction from a user. The vectorizing includes identifying the attribute of the image in the determined area based on the generated attribute data, and performing vectorization on the area in the raster image data based on the identified attribute of the image.

According to another aspect of the present invention, there is provided a computer readable storage medium adapted to store a computer program for causing a computer to execute the above image processing method.

According to an exemplary embodiment of the present invention, higher precision vectorization can be performed on image data stored based on print data received by an image processing apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a configuration of an image processing system.

FIG. 2 is a block diagram illustrating an example of a configuration of a multifunction peripheral (MFP).

FIG. 3 is a flowchart illustrating an example of an operation of an internal central processing unit (CPU) of a data processing unit.

FIG. 4 is a view illustrating an example of an operation window displayed in a user interface unit.

FIG. 5 is a view illustrating an example of an operation window displayed in the user interface unit.

FIG. 6 is a view illustrating an example of an operation window displayed in the user interface unit.

FIG. 7 is a view illustrating an example of a reprint history table.

FIGS. 8A and 8B are views illustrating an example of a block selection.

FIG. 9 is a table illustrating an example of block information.

FIG. 10 is a view illustrating outline vectorization processing.

FIG. 11 is a view illustrating outline vectorization processing.

FIGS. 12A and 12B illustrate points on an outline, which are deleted at outline vectorization.

FIGS. 13A to 13D illustrate how contour points are iteratively deleted by employing only a second deletion condition.

FIG. 14 is a table illustrating parameters for performing contour point deletion processing on a text area, a graphic area, and a table area.

FIG. 15 is a flowchart illustrating an example of an adaptive contour point deletion process.

FIG. 16 is a flowchart illustrating an example of an object recognition process for grouping vector data corresponding to each object.

FIG. 17 is a flowchart illustrating an example of an element detection process.

FIG. 18 is a table illustrating an example of a data structure of document analysis output format (DAOF) data.

FIG. 19 is a flowchart illustrating an example of an application data conversion process.

FIG. 20 is a flowchart illustrating an example of a document structure tree generation process.

FIGS. 21A and 21B illustrate an actual page configuration and an example of a document structure tree of the page shown in FIG. 21A, respectively.

FIG. 22 is a flowchart illustrating an example of a process for extracting, changing and reflection processing on vector data.

FIG. 23 is a flowchart illustrating an example of a vector data generation process for generating vector data from an attribute map.

FIG. 24 is a flowchart illustrating an example of a process for conversion-to-vector-data and componentisation of vector data.

FIG. 25 is a flowchart illustrating an example of a vector data replacement process.

FIG. 26 illustrates an example of a user-specified information table.

FIG. 27 illustrates a process for vectorizing raster image data.

### DETAILED DESCRIPTION OF THE EMBODIMENTS

Various exemplary embodiments, features, and aspects of the invention will be described in detail below with reference to the drawings.

Entire System Configuration

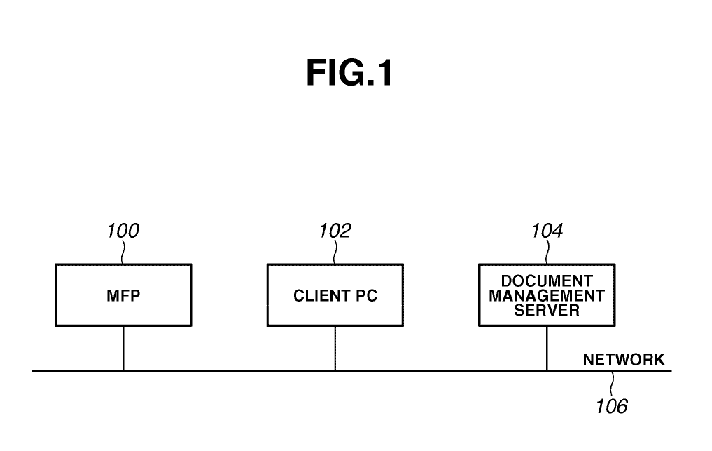

FIG. 1 is a block diagram illustrating an example of a configuration of an image processing system according to an exemplary embodiment of the present invention. As shown in FIG. 1, a multifunction peripheral (MFP) 100, a client personal computer (PC) 102, and a document management server 104 are connected to a network 106 including a local area network (LAN).

The MFP 100 serving as an example of an image processing apparatus has multiple functions, such as a copying function, a scanner function, a facsimile function, and a printer function. The MFP 100 receives print data sent from the client PC 102 and rasterizes the print data into raster image data. Then, the MFP 100 performs an image forming process according to the raster image data. This process is performed according to the printer function of the MFP 100.

The MFP 100 also can rasterize the print data received from the client PC 102 into the raster image data, store the raster image data in a storage unit 112 which will be described later, and transfer the raster image data to the document management server 104. This enables the MFP 100 to reprint the print data by reading the raster image data from the storage unit 112 or the document management server 104, without causing the client PC 102 to send the same print data as that having once been received from the client PC 102 by the MFP 100.

The client PC 102 serving as an example of an information processing apparatus sends print data to the MFP 100. The print data may be either page description language (PDL) data or raster image data.

The document management server 104 stores image data (including the raster image data), which is handled in an image input/output process performed by the MFP 100, in a storage unit (not shown) provided therein. Also, the document management server 104 reads image data stored in the storage unit (not shown) in response to a request from the MFP 100, and sends the read image data to the MFP 100.

Although the MFP 100 has been described as an apparatus having the multiple functions with reference to FIG. 1, it is sufficient that the MFP 100 has at least the function of processing print data sent from the client PC 102.

Configuration of MFP 100

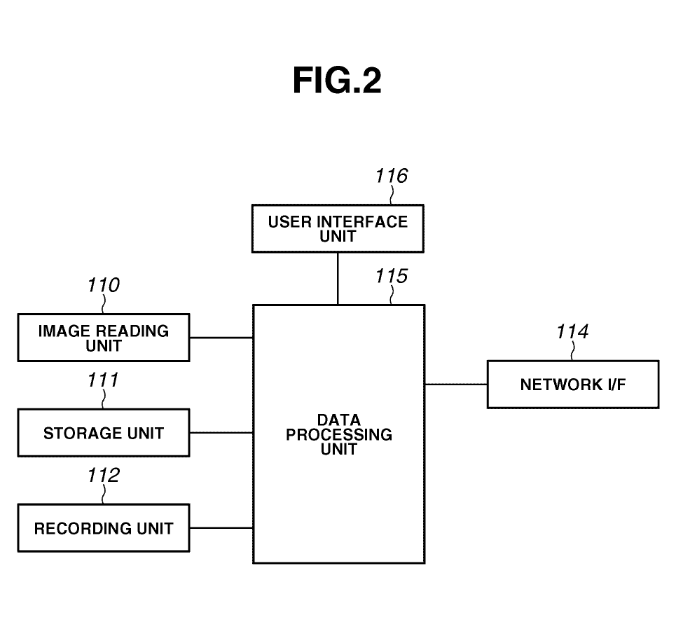

FIG. 2 is a block diagram illustrating an example of the configuration of the MFP 100. An image reading unit 110 including an auto document feeder (ADF (not shown)) reads a single or a bundle of sheets of originals and generates raster image data as image information representing an image having a pixel density of 600 dpi (dots per inch).

A storage unit 111 includes a nonvolatile mass storage device, for example, a hard disk, and stores image data, which is generated by the image reading unit 110, and raster image data (to be described later). The storage unit 111 also stores programs to be executed by a CPU (not shown) included in a data processing unit 115 to control the entire MFP 100 or each of the units of the MFP 100.

A recording unit 112 forms an image on paper according to image data generated by the image reading unit 110 or print data received from the client PC 102. The recording unit 112 may be adapted to form an image by an electrographic method, or alternatively, another method, such as an inkjet method or a thermal transfer method.

A network interface 114 is enabled to perform input/output of data through the network 106.

The data processing unit 115 performs overall control of the MFP 100 and controls each of the units connected thereto. The data processing unit 115 has a CPU (not shown), a RAM (random access memory (not shown)), and a ROM (read-only memory (not shown)).

A user interface unit 116 displays operation information, image data, and raster image data used in the MFP 100. The user interface unit 116 receives a signal representing an operation, which is input by a user. The user interface unit 116 includes a liquid crystal display unit having a touch panel, hardware keys, such as a ten-key device, and a pointing device, such as a mouse.

In a case where the MFP 100 performs a copying function, the data processing unit 115 performs image processing on image data generated by the image reading unit 110. The image data processed by the data processing unit 115 is serially output to the recording unit 112 to form an image on paper.

In a case where the MFP 100 performs a print function, the MFP 100 receives print data, which is output from the client PC 102, through the network interface 114 from the network 106. The data processing unit 115 rasterizes the received print data into raster image data. Thereafter, the recording unit 112 forms a recorded image on paper.

In the case where the MFP 100 performs the print function, the raster image data obtained by rasterizing the received print data is stored in the storage unit 111. According to some instructions issued from the client PC 102 or to some setting of the MFP 100, the MFP 100 can cause the storage unit 111 to store the raster image data, without printing the raster image data after rasterizing the print data received from the client PC 102 into the raster image data. This process for storing the raster image data in the storage unit 111 without printing the raster image data is referred to as a “box job” in the exemplary embodiment.

The raster image data obtained by performing the print function and the box job may be sent to the document management server 104 and may be stored in a storage device (not shown) in the document management server 104, instead of being stored in the storage unit 111 of the MFP 100.

Overview of Operation of MFP 100

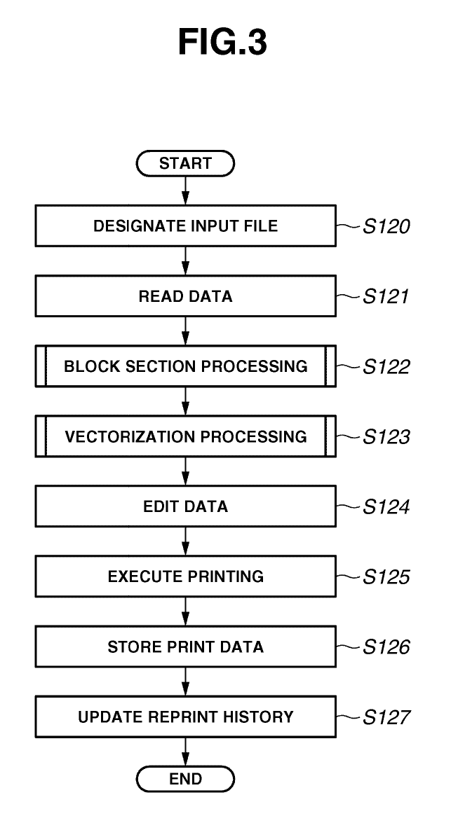

FIG. 3 is a flowchart illustrating an example of an operation of the internal CPU of the data processing unit 115 of the MFP 100. The following description is made by assuming that the data processing unit 115 performs processing, for simplicity of description. However, in some steps, a unit other than the data processing unit 115 of the MFP 100 may perform processing.

The flowchart shown in FIG. 3 illustrates an overview of an operation of performing the print function and the box job to reprint or edit the raster image data stored in the storage unit 111 of the MFP 100.

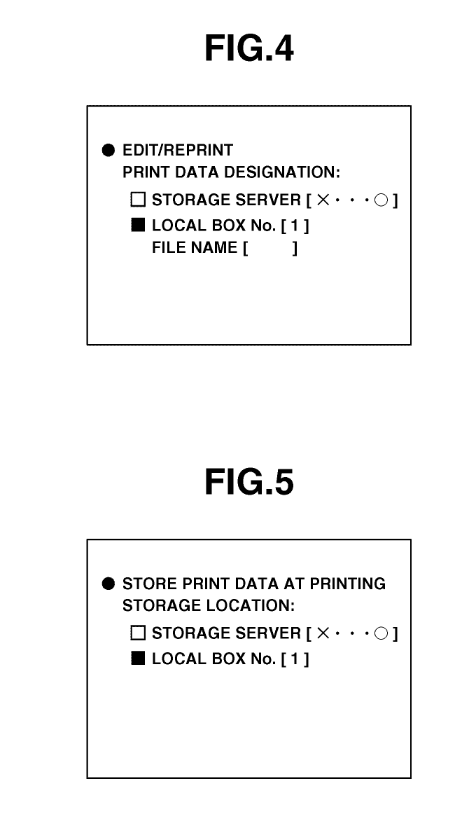

In step S120, the data processing unit 115 receives an operation instruction issued by a user of the MFP 100 through the user interface unit 116. FIG. 4 illustrates an operation window displayed in the user interface unit 116 in this case. Then, the data processing unit 115 specifies raster image data, which is to be reprinted or edited, in the storage unit 111. An input file corresponding to the raster image data, which is to be reprinted or edited, may be designated from the storage unit 111 in the MFP 100. Alternatively, as shown in FIG. 4, the input file corresponding to the raster image data, which is to be reprinted or edited, may be designated from the document management server 104 serving as an external storage server placed outside the MFP 100.

In step S121, the data processing unit 115 reads the raster image data corresponding to the input file designated in step S120.

In step S122, the data processing unit 115 performs block selection processing (BS processing) on the raster image data read in step S121. The BS processing will be described in detail later in the section “Block Selection Processing”.

Subsequently, in step S123, the data processing unit 115 performs vectorization processing on the raster image data on which the BS processing has been performed in step S122. The vectorization processing will be described in detail later in the section “Vectorization Processing”.

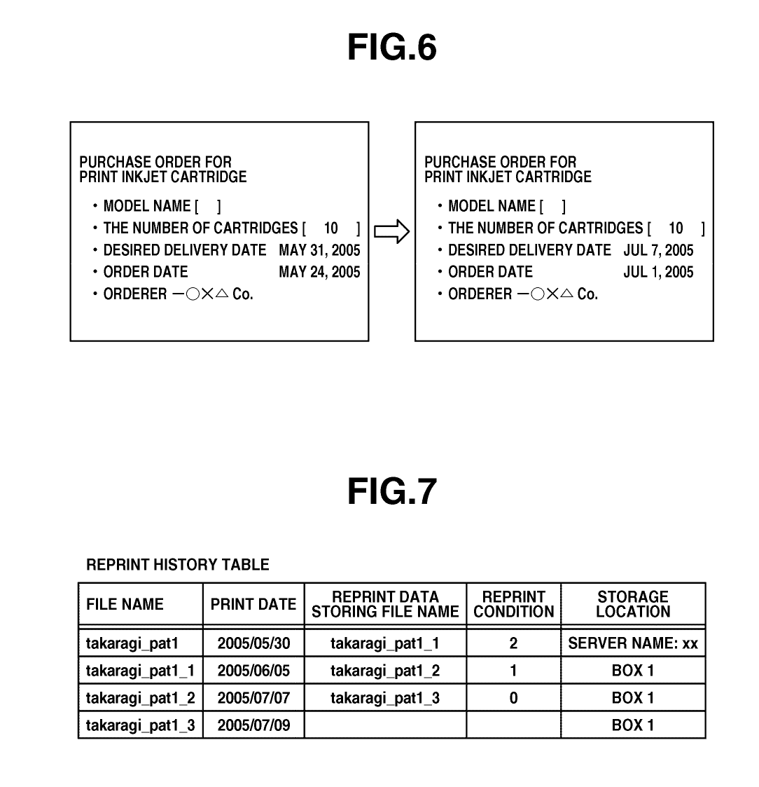

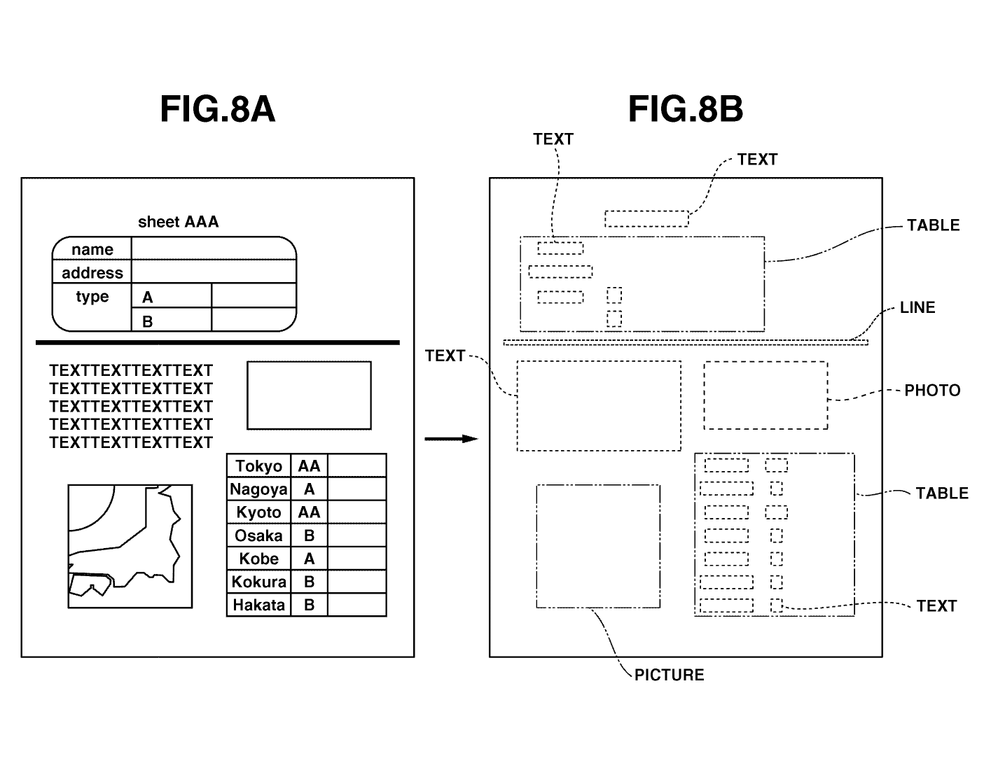

In step S124, the data processing unit 115 displays vectorized data in the user interface unit 116. Then, as shown in FIG. 6, the data processing unit 115 receives an edit instruction on the vectorized data displayed in the user interface unit 116. Subsequently, the data processing unit 115 performs an edit process on the vectorized data according to the edit instruction from a user. More specifically, the data processing unit 115 performs edit processing by changing data (hereunder referred to as “DAOF data”) of Document Analysis Output Format (DAOF) shown in FIG. 8, which is used as the vectorized data.

In step S125, under the control of the data processing unit 115, the recording unit 112 regenerates print data (raster image data) from the DAOF data edited in step S124. Then, printing is performed thereon.

In step S126, the data processing unit 115 displays an operation window in the user interface unit 116, as shown in FIG. 5. Then, the DAOF data edited in step S124 is stored at a storage location designated by an operation instruction input by a user from the operation window.

In step S127, the data processing unit 115 updates data representing a reprint history table shown in FIG. 7. The data representing the reprint history table is stored in the internal memory of the data processing unit 115.

In a reprint condition shown in FIG. 7, a value of “0” indicates that no change is performed. A value of “1” indicates that only a print condition is changed (for example, one-sided printing is changed to two-sided printing). A value of “2” indicates that data to be printed is changed (for example, contents of sentences are changed). The reprint condition is designated by a user through the user interface unit 116.

Block Selection Processing

The block selection processing performed in step S122 shown in FIG. 3 is described in detail below. For example, image data shown in FIG. 8A is recognized as a plurality of groups of objects, as shown in FIG. 8B. Each of the groups is determined and classified according to attributes, such as a text attribute, a picture attribute, a photo attribute, a line attribute, and a table attribute. A group of objects of different attributes is divided into blocks. In FIG. 8B, the group “TEXT” corresponds to a text area (or block). The group “PICTURE” corresponds to a picture (or graphic) area. The group “TABLE” corresponds to a tabular form area (or table area). The group “LINE” corresponds to a line drawing area. The group “PHOTO” corresponds to a photo area. Types of areas are not limited to these types. Another type of an area may be employed.

Hereinafter, an example of the block selection processing is described. First, the data processing unit 115 binarizes the data read in step S121 shown in FIG. 3, which shows an input image, into binary image data including black pixels and white pixels. Then, a group of pixels surrounded by a black-pixel contour is extracted by performing contour tracing processing. The data processing unit 115 also performs contour tracing processing on white pixels contained in a large-area group of black pixels to extract a group of white pixels therefrom. Also, the data processing unit 115 recursively extracts a group of black pixels from a group of white pixels in a case where the area of the group of white pixels is equal to or larger than a predetermined value.

The data processing unit 115 classifies groups of black pixels by size and shape into areas of different attributes. For example, in a case where the aspect ratio of a group of black pixels is close to 1, and where the size of the group of black pixels is within a predetermined range, the data processing unit 115 classifies the group of black pixels as a group of pixels, which corresponds to a character. Also, the data processing unit 115 classifies a group of black pixels, in which adjacent parts respectively corresponding to characters are well aligned and can be grouped, as a text area. Additionally, the data processing unit 115 classifies a flat group of pixels as a line area. Further, in a case where the size of a group of black pixels is equal or larger than a predetermined value, and where the group of black pixels contains well aligned rectangular groups of white pixels, the data processing unit 115 classifies the group of black pixels as a table area. Also, the data processing unit 115 classifies an area, in which indeterminate-shape groups of pixels are scattered, as a photo area. Additionally, the data processing unit 115 classifies a group of pixels, which has another arbitrary shape, as a picture area.

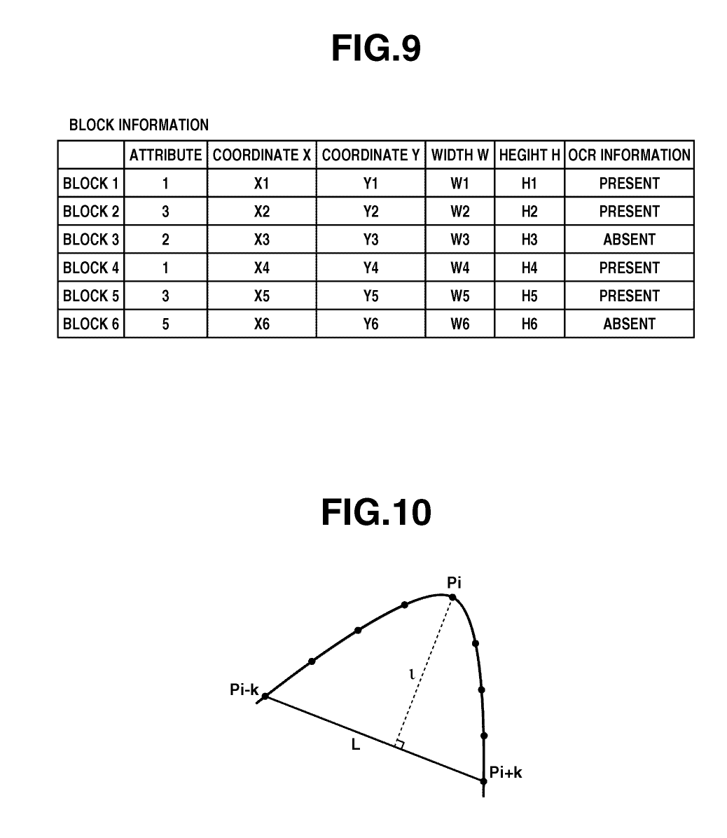

FIG. 9 shows block information representing each of the blocks obtained by the block selection processing. The information corresponding to each of the blocks, which is shown in FIG. 9, is utilized in the vectorization processing and retrieval processing, which are described below.

In a column representing attributes in a table shown in FIG. 9, a value of “1” designates a text attribute. A value of “2” designates a picture attribute. A value of “3” designates a table attribute. A value of “4” designates a line attribute. A value of “5” designates a photo attribute. The information shown in FIG. 9 is stored in, for example, the internal memory of the data processing unit 115.

Vectorization Processing

The vectorization processing, that is, the DAOF data generation processing performed in step S123 of the flowchart shown in FIG. 3 is described in detail below. First, the data processing unit 115 performs character recognition processing on a text block. The vectorization processing is implemented by performing a plurality of kinds of processing, such as character recognition processing, outline vectorization processing, graphic recognition processing, and conversion-to-DAOF processing. Hereinafter, each of the plurality of kinds of processing is described.

Character Recognition Processing

The data processing unit 115 performs character recognition processing on an image extracted in units of characters, using a technique for pattern matching processing. Thus, a corresponding character code is obtained. This recognition processing is to compare an observed feature vector, which is obtained by converting a feature vector obtained from a character image into several-tens-dimensional numeric series, with a dictionary feature vector preliminarily obtained corresponding to each kind of a letter, so that a kind of a letter having a shortest distance to the observed feature vector is a result of the recognition. There are various kinds of publicly known techniques for extraction of a feature vector. For example, there has been provided a method of employing a vector, the number of dimensions of which is the number of cells of a mesh, obtained by dividing a character into cells of a mesh and counting character lines as linear elements corresponding to each direction.

In a case where character recognition is performed on a text area (text block) extracted by the block selection processing, first, the data processing unit 115 determines whether this area is a vertical-writing area or a horizontal-writing area. Then, the data processing unit 115 extracts a line in a direction corresponding to each of the vertical-writing and the horizontal-writing. Subsequently, the data processing unit 115 extracts a character therefrom to obtain a character image.

Then, the data processing unit 115 obtains horizontal and vertical projections of each of pixel values in this area. In a case where the dispersion of the horizontal projection is large, the data processing unit 115 determines that this area is a horizontal-writing area. Conversely, in a case where the dispersion of the vertical projection is large, the data processing unit 115 determines that this area is a vertical-writing area. Additionally, with respect to the horizontal-writing area, the data processing unit 115 extracts a line using horizontal projections and, then, extracts a character from vertical projections on the extracted line to obtain a character image. The data processing unit 115 further extracts a line using vertical projections and, then, extracts a character from horizontal projections on the extracted line to obtain a character image.

Outline Vectorization Processing

Subsequently, the data processing unit 115 converts an outer contour of a group of pixels, which are extracted from areas determined in the block selection processing as, for example, a text area, a line area, and a table area, into vector data.

More specifically, the data processing unit 115 divides a sequence of points constituting the outline at a point regarded as a “vertex”. Then, the data processing unit 115 approximates each of sections with a partial straight or curved line. The “vertex” is a point at which curvature is maximal. As illustrated in FIG. 10, the data processing unit 115 obtains the point, at which curvature is maximal, as a point at which the distance l from a given point Pi to a chord L drawn between points Pi−k and Pi+k horizontally spaced from the given point Pi is maximal.

Also, the data processing unit 115 regards a point, at which a value R of (the length of the chord)/(the length of the arc) drawn between the points Pi−k and Pi+k is equal to or less than a threshold value, as the “vertex”. The data processing unit 115 vectorizes the sections, which are obtained by dividing the contour at the “vertexes”, by applying a least square method to the sequence of points of the section in a case where the section is a straight line, or utilizing a three-dimensional spline function in a case where the section is a curved line, to approximate each of the sections. The vectorized data (vector data) is stored in, for example, the internal memory of the data processing unit 115.

In a case where an object has an inner contour, the data processing unit 115 similarly approximates sections of the inner contour with partial straight or curved lines, using a sequence of points of the inner contour constituted by white pixels extracted in the block selection processing. Thus, the data processing unit 115 can vectorize outlines of arbitrarily shaped characters, lines, tables, and graphics, by approximating the contours with sectioned lines (including sectioned curves (or piecewise-lines including piecewise-curves)). In a case where the original image data represents a color image, the data processing unit 115 extracts a color of each graphic from the color image and records information representing the extracted color together with the vector data.

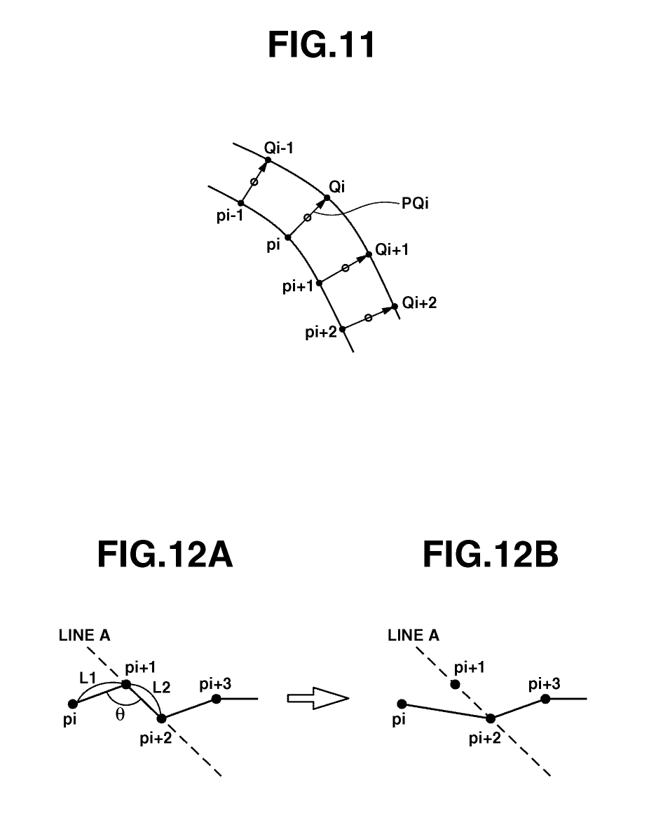

In a case where an outer contour is close to an inner contour or another outer contour in a section, as shown in FIG. 11, the data processing unit 115 can treat the two contours as a single line having a thickness. That is, in a case where segments respectively drawn from points Pi on one of the contours to associated points Qi on the other contour so that each of the segments between the associated points Pi and Qi corresponds to a shortest distance therebetween, and where the average of the distances PQi is equal to or less than a predetermined length, the data processing unit 115 approximates a sequence of midpoints of the segments PQi in the section in question with a straight or curved line by setting the thickness of the line at an average value of the distances PQi. Vectorial representation of ruled lines of a table, which are straight lines or a set of lines, can efficiently be achieved.

Hereinafter, an example of adaptive application of the outline vectorization processing to characters, lines, tables, and graphics is described by referring to FIGS. 12A and 12B illustrating points (hereunder sometimes referred to simply as deletion points) on a contour, which are to be deleted at the outline vectorization.

In a case where a large number of deletion points are employed according to predetermined rules, an amount of obtained data representing outlines is reduced. However, an error of an outline represented by vectorization from the contour is increased. According to the present embodiment, this deletion processing is adaptively applied according to the attributes of image blocks. Consequently, the present embodiment can achieve both of reduction in amount of data representing the vectorized image block of each attribute and maintenance of picture quality.

First, rules for deletion of contour points are described below. Vector data described in the following description of the rules is that representing outline characters obtained by connecting the remaining points on a contour of an image, such as a character, which are other than the deleted points. Consider a case where four connected points Pi, Pi+1, Pi+2, and Pi+3 are present before contour point data is corrected, as shown in FIG. 12A.

A first deletion condition is as follows: “both of a distance L1 between the first point Pi and the second point Pi+1 and a distance L2 between the second point Pi+1 and the third point Pi+2 are less than a predetermined distance Lc.”

A second deletion condition is as follows: “in a case where the first point Pi and the fourth point Pi+3 are located in opposite regions with respect to a straight line A connecting the second point Pi+1 and the third point Pi+2, and where the first point Pi is placed on the straight line, the second point Pi+1 is deleted.”

A third deletion condition is as follows: “in a case where an angle θ of intersection of a segment drawn between the first point Pi and the second point Pi+1 and a segment drawn between the second point Pi+1 and the third point Pi+2 is within a predetermined angular range θc, the second point Pi+1 to be deleted is set to be a key point, which is not deleted.”

When a constant Lc according to the condition for deletion of the point Pi+1 is increased, possibility of deletion thereof increases. Thus, the outline vectorization of an object image can be achieved by a group of long straight lines. Although an amount of information is reduced, a contour finely changing easily disappears after the outline vectorization.

Similarly, when the predetermined angular range θc is reduced, the possibility of deletion of the point Pi+1 is increased. The outline vectorization processing can be achieved so that the object image is more smoothly vectorized. Although an amount of information is reduced, features of small-size characters are lost.

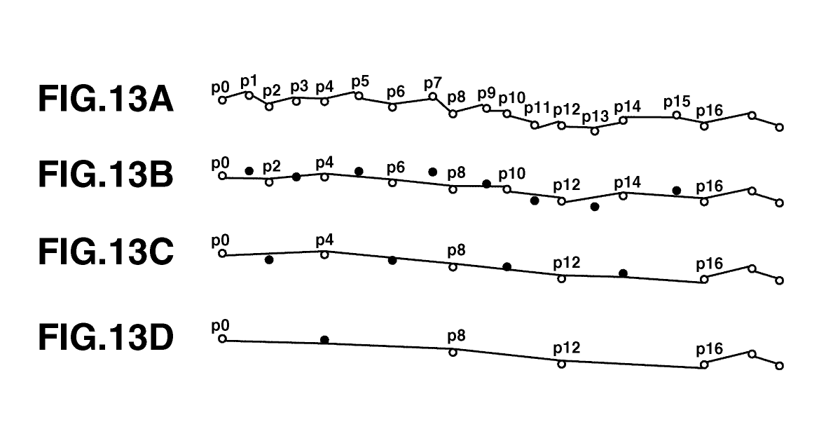

The data processing unit 115 checks these deletion conditions. Also, the data processing unit 115 iteratively performs the deletion processing on a result of serially deleting the contour points, that is, on the remaining contour points. Consequently, a larger number of the contour points can be deleted. FIGS. 13A to 13D illustrate how contour points are iteratively deleted by employing only the second deletion condition. Among 17 contour points P0 to P16 shown in FIG. 13A, 8 points P1, P3, P5, P7, P9, P11, P13, and P15 are deleted by performing the deletion processing once (see FIG. 13B).

When the deletion processing is sequentially performed on the remaining points shown in FIG. 13B from the point P0, the contour points P2, P6, P10, and P14 are deleted, as shown in FIG. 13C. Similarly, when the deletion processing is sequentially performed on the remaining contour points shown in FIG. 13C from the point P0 again, the contour point P4 is deleted, as shown in FIG. 13D. That is, the larger the number of times the deletion processing is repeated, the larger the number of points are deleted. The outline vectorization processing can be achieved so that the object image is more smoothly vectorized. An amount of information is reduced.

According to the present embodiment, the deletion processing is performed on the contour points according to the attribute of a corresponding block. That is, when the outline vectorization of an image corresponding to each of parts into which each image block is divided, the data processing unit 115 deletes the contour points by using parameters adaptively set according to the attribute of the block.

As described above, the parameters for performing the deletion processing by the data processing unit 115 are the constant Lc determining the lengths L1 and L2 of segments respectively connecting two sets of the adjacent two points, the angular range θc determining an apex angle formed between the two sides respectively corresponding to the lengths L1 and L2, and the number N of times of deletion of the contour points.

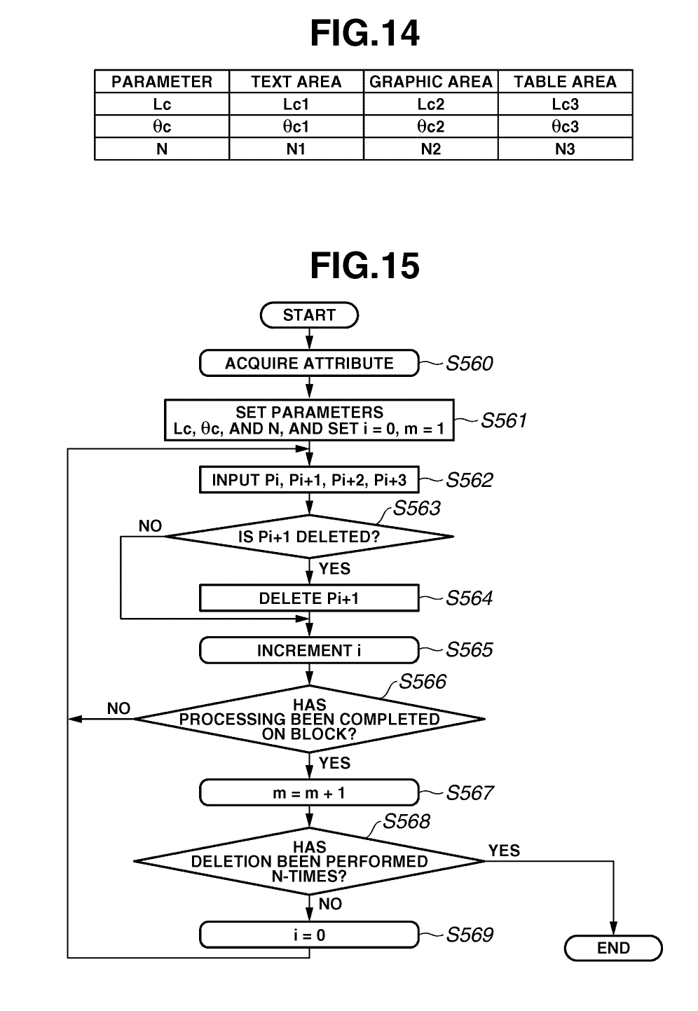

FIG. 14 is a table showing the parameters for the contour point deletion processing to be performed on the text area, the graphic area, and the table area. Generally, among these three areas, the text area has a highest spatial frequency. The table area has a lowest spatial frequency. Thus, when the outline vectorization of the contour of each character included in the text area is performed, it is necessary to faithfully perform the outline vectorization thereon without deleting small change. Most of objects included in the table area are long straight lines. Thus, an amount of information can be reduced, and the outline vectorization can be achieved faithfully to the original image by deleting a larger number of contour points from the table area to enhance the linearity of groups of pixels contained in the table area. The graphic area is treated so that the number of deletion points therefrom has an intermediate value between those of the numbers of deletion points, which respectively correspond to the text area and the table area. That is, the parameters corresponding to each of the areas are set so that the number of contour points deleted from the text area is smallest, and that the number of contour points deleted from the table area is largest.

The parameters shown in FIG. 14 are set so that Lc1<Lc2<Lc3, that θc1>θc2>θc3, and that N1<N2<N3.

FIG. 15 is a flowchart illustrating an example of an adaptive contour point deletion process. First, in step S560, the data processing unit 115 acquires information representing the attribute of a block, which is to be processed, from the block information shown in FIG. 9.

Subsequently, in step S561, the data processing unit 115 acquires the values of the parameters Lc, θc, and N corresponding to the attribute of the block, which is obtained in step S560. Also, the data processing unit 115 sets the parameters i and m at 0. In step S562, the data processing unit 115 reads data representing three consecutive points Pi+1, Pi+2, and Pi+3 from a leading contour point Pi of the contour points contained in the block.

In step S563, the data processing unit 115 checks the three deletion conditions using the parameters set in step S561. If the data processing unit 115 determines that the point Pi+1 is a deletion point, the process proceeds to step S564. If the data processing unit 115 determines that the point Pi+1 is not a deletion point, the process proceeds to step S565.

In step S564, the data processing unit 115 deletes the point Pi+1. In step S565, the data processing unit 115 changes the contour point, which is checked whether the deletion conditions are satisfied, to the next point. That is, the value of the parameter i is incremented by 1.

In step S566, the data processing unit 115 determines whether the deletion processing has been performed on all of the contour points in the block to be processed. If the data processing unit 115 determines that the deletion processing has been performed on all of the contour points, the process advances to step S567. If not, the process returns to step S562.

That is, the data processing unit 115 performs processing, which is to be performed in steps S562 to S566, on all of the contour points in the block to be processed.

In step S567, the data processing unit 115 determines that the processing, which is to be performed in steps S562 to S566, has been performed once on all of the contour points in the block. Thus, the value of the parameter m is incremented by 1.

In step S568, the data processing unit 115 compares the value of the parameter m with that of the parameter N, and determines whether the value of the parameter m is equal to that of the parameter N. If the data processing unit 115 determines that the value of the parameter m is equal to that of the parameter N, the data processing unit 115 also determines that the deletion processing has been performed N times. Then, the process illustrated in FIG. 15 is finished. On the other hand, if the data processing unit 115 determines that the value of the parameter m is less than the value of the parameter N, the data processing unit 115 also determines that the deletion processing has been not performed N times. Then, the process proceeds to step S569.

In step S569, the data processing unit 115 sets the parameter i at 0. Then, the process returns to step S562.

In the outline vectorization processing performed on the remaining contour points after the deletion processing, the vectorization may be performed by approximating each of the sections using either a straight line or a Bezier curve drawn using a Bezier function.

Graphic Recognition Processing

Hereinafter, a process for grouping vector data corresponding to each of a graphic object and a character object is described.

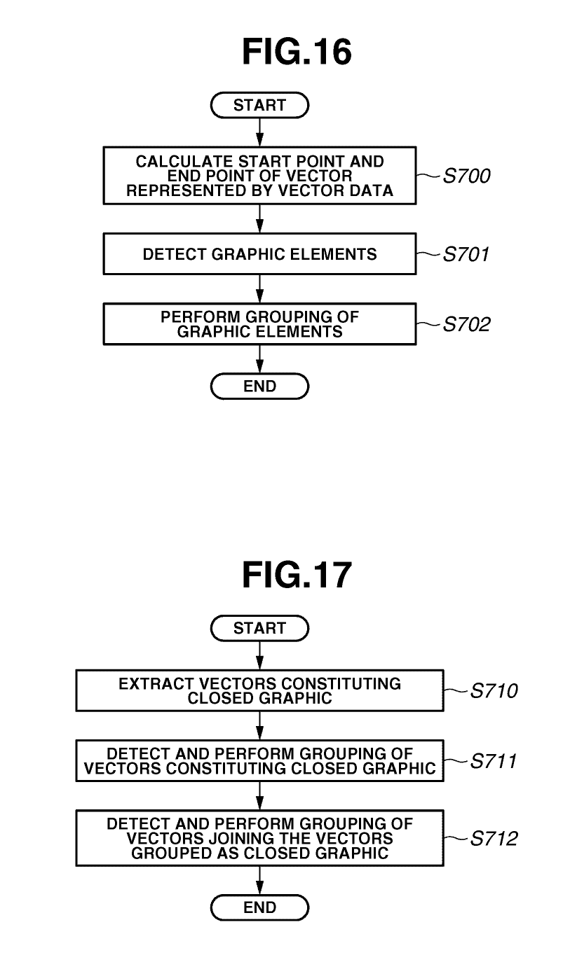

FIG. 16 is a flowchart illustrating an example of an object recognition process for grouping vector data corresponding to each object.

In step S700, the data processing unit 115 calculates a start point and an end point of each of vectors represented by vector data. Subsequently, in step S701, the data processing unit 115 detects a graphic element and a character element using information on a start point and an end point of each vector. The detection of each element is that of a closed graphic composed of sectioned lines. At the detection of each element, the data processing unit 115 applies to the detection of element a principle that there are vectors respectively connected to both ends of each vector constituting a closed graphic. Element detection processing is described below in detail with reference to FIG. 17.

Subsequently, in step S702, the data processing unit 115 performs the grouping of elements, which are present in each element, or of sectioned lines, which are present in each element, to form one graphic or character object. If another element or sectioned line is not present in each element, the data processing unit 115 converts each element into a graphic or character object.

FIG. 17 is a flowchart illustrating an example of an element detection process. First, in step S710, the data processing unit 115 removes unnecessary vectors, the both ends of each of which are not connected to other vectors, from vectors represented by the vector data. Thus, the data processing unit 115 extracts vectors constituting each closed graphic.

Subsequently, in step S711, the data processing unit 115 traces the vectors, which constitute a closed graphic, serially clockwise from a start point of one of vectors, which serves as a start point for tracing. Then, the data processing unit 115 performs the grouping of all the vectors, which are passed by tracing, as a single closed graphic element. Also, the data processing unit 115 performs the grouping of all of vectors included in a closed element (vectors constituting a closed element). Then, the data processing unit 115 traces the ungrouped vectors serially clockwise from a start point of one of the ungrouped vectors, which serves as a start point for tracing, among the vectors that constitute a closed graphic. Then, the data processing unit 115 iteratively performs the grouping of all the vectors, which are passed by tracing, as a single closed graphic element.

Finally, in step S712, the data processing unit 115 detects vectors connected to the vectors grouped in step S711 as a closed graphic element, among the unnecessary vectors removed in step S710. Then, the data processing unit 115 performs the grouping of the detected vectors.

The above-described processes enable the apparatus to treat a graphic block and a text block as a graphic object and a text object, respectively. vector data representing vectors, which are obtained by performing the outline vectorization on each of characters included in a text block, and which are connected as one character element, can be treated as what is called outline font data corresponding to a character code obtained by the above-described character recognition. That is, the outline font data includes information of the character style of a character, in addition to the character code obtained by the character recognition. Thus, the outline font data is character vector data that is visually faithful to an original image and that can be edited.

Conversion-to-DAOF Processing

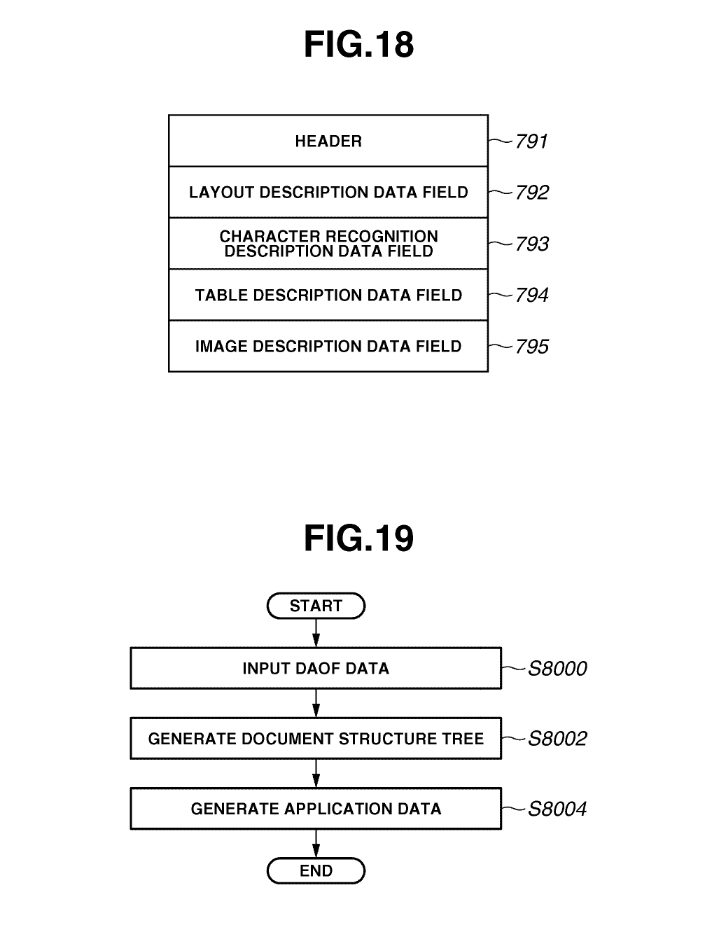

Meanwhile, results of performing the block selection processing (corresponding to step S122 shown in FIG. 3) and performing a vectorization process (corresponding to step S123 shown in FIG. 3) on image data of one page are converted to and are stored as a file of an intermediate data format shown in FIG. 18, which will be described later. Data of such a data format is referred to as DAOF data.

FIG. 18 is a table illustrating an example of a data structure of DAOF data. In FIG. 18, a header 791 holds information on document image data to be processed. A layout description data field 792 holds attribute information of each of blocks recognized corresponding to attributes, such as TEXT, TITLE, CAPTION, LINEART, EPICTURE, FRAME, and TABLE in document image data, and address information corresponding to each of the rectangular blocks. TEXT, TITLE, CAPTION, LINEART, EPICTURE, FRAME, and TABLE designate a text attribute, a title attribute, a caption attribute, a line attribute, a natural image attribute, a frame attribute, and a table attribute, respectively.

A character recognition description data field 793 holds data representing results of character recognition, such as TEXT, TITLE, and CAPTION, which are obtained by performing character recognition on a TEXT block. A table description data field 794 stores detail information on a structure of a TABLE block. An image description data field 795 holds image data representing a PICTURE block and a LINEART block, which are extracted from the document image data.

The DAOF shown in FIG. 18 may be not only used as intermediate data but stored as a file in the internal memory of the data processing unit 115. Hereinafter, an application data conversion process adapted to convert this DAOF to application data, which is necessary in a case where individual objects are reused in what is called a document creation application program, is described.

FIG. 19 is a flowchart illustrating an example of the application data conversion process. In step S8000, the data processing unit 115 inputs (or acquires) DAOF data. The data processing unit 115 acquires DAOF data, which is stored as a file, from, for example, the internal memory.

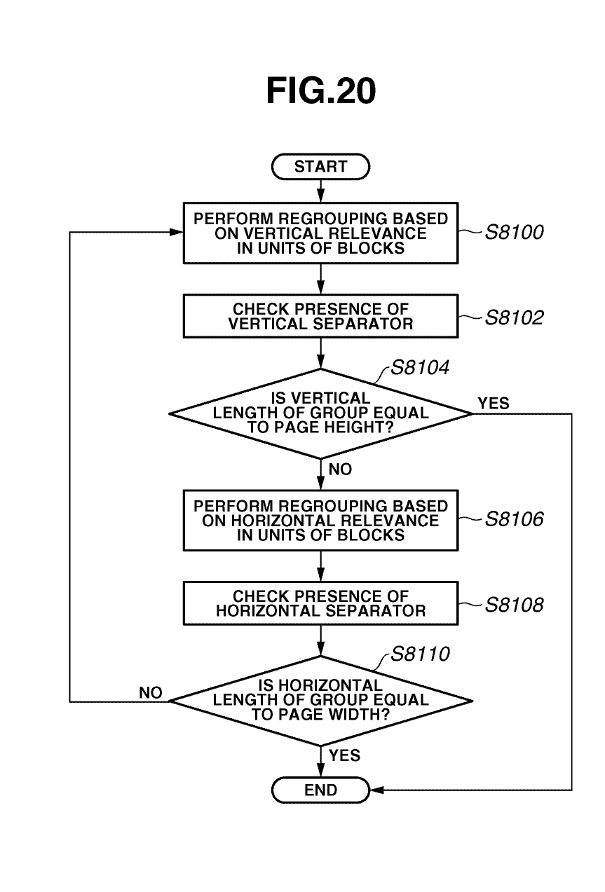

In step S8002, the data processing unit 115 generates a document structure tree, according to which application data is generated, by using DAOF data. A document structure tree is described below with reference to FIG. 20. In step S8004, the data processing unit 115 inserts or flows DAOF data into a document structure tree to generate application data.

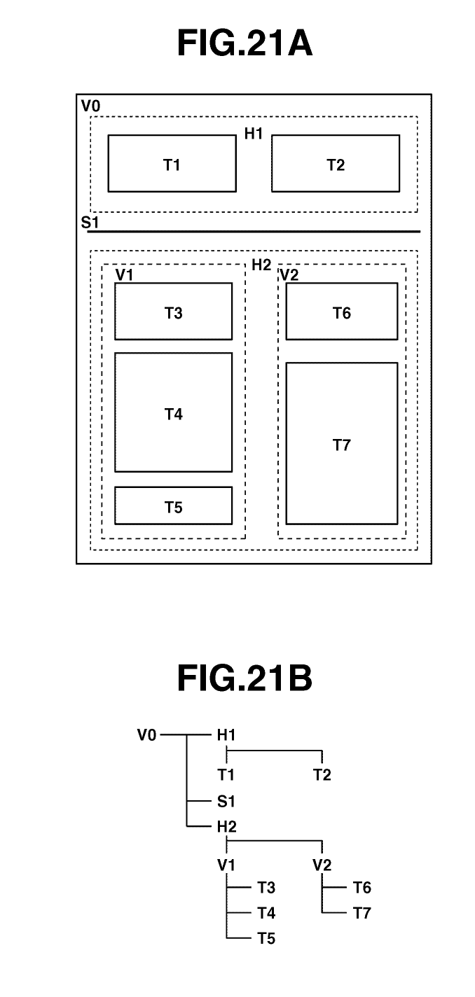

FIG. 20 is a flowchart illustrating an example of a document structure tree generation process. FIGS. 21A and 21B illustrate an example of the document structure tree. In the process shown in FIG. 20, as a basic rule, processing is shifted from a microblock (a single block) to a macroblock (a set of blocks). Unless otherwise noted, for brevity of description, both of the microblock and the macroblock are referred to simply as the block in the following description.

In step S8100, the data processing unit 115 performs regrouping in units of blocks according to vertical relevance thereamong. The relevance is determined by checking, for example, whether a distance between the blocks is small, or whether blocks have substantially the same width (height in a case of horizontal relevance). The data processing unit 115 extracts information on the distance, the width, and the height from the DAOF data, and utilizes the extracted information. Just after processing is started in step S8100, the data processing unit 115 makes a determination (thus, the regrouping) in units of microblocks.

FIG. 21A illustrates an example of an actual page configuration and FIG. 21B illustrates an example of a document structure tree of the page shown in FIG. 21A. As a result of the processing in step S8100, a group V1 including blocks T3, T4, and T5, and a group V2 including blocks T6, and T7 are generated as groups belonging to the same hierarchical layer.

In step S8102, the data processing unit 115 checks whether a vertical separator is present. The “separator” is physically defined as an object having a line attribute in an image represented by DAOF data. Also, the “separator” is logically defined as an element explicitly dividing a block in an application program. In a case where the data processing unit 115 detects the separator, a group is divided in the same hierarchical layer to which the separator belongs.

In step S8104, the data processing unit 115 determines according to a vertical grouping length whether no more divisions may occur. If the vertical grouping length is equal to a page height, the data processing unit 115 finishes the document structure tree generation process. On the other hand, if the data processing unit 115 determines that the vertical grouping length is not equal to the page height, the process proceeds to step S8106.

In step S8106, the data processing unit 115 performs regrouping in units of blocks according to horizontal relevance thereamong. Similarly to the relevance in the case of the vertical relevance, the horizontal relevance is determined by checking, for example, whether a distance between the blocks is small, or whether blocks have substantially the same height. The data processing unit 115 extracts information on the distance, the width, and the height from the DAOF data, and utilizes the extracted information. Immediately after processing is started in step S8106, the data processing unit 115 makes a determination (thus, the regrouping) in units of microblocks.

In the example shown in FIGS. 21A and 21B, as a result of the processing in step S8100, the group V1 including the blocks T3, T4, and T5, and the group V2 including the blocks T6, and T7 are generated as the groups belonging to the same hierarchical layer. As a result of the processing in step S8106, a group H1 including blocks T1 and T2 and a group H2 including the groups V1 and V2 are generated as groups belonging to the same hierarchical layer that is higher by one level than the layer to which the groups V1 and V2 belong.

In step S8108, the data processing unit 115 checks whether a horizontal separator is present. In a case where the data processing unit 115 detects the separator, a group is divided in the same hierarchical layer to which the separator belongs. In the case shown in FIGS. 21A and 21B, a horizontal separator S1 is present. Thus, the data processing unit 115 registers the horizontal separator S1 in the document structure tree (that is, adds the separator S1 thereto).

In the example shown in FIGS. 21A and 21B, as the results of the processing in steps S8106 and S8108, a hierarchical layer, to which the groups H1 and H2 and the separator S1 belong, is generated. In step S8110, the data processing unit 115 determines according to a horizontal grouping length whether no more divisions may occur. If the horizontal grouping length is equal to a page width, the data processing unit 115 finishes the document structure tree generation process. On the other hand, if the data processing unit 115 determines that the vertical grouping length is not equal to the page width, the process returns to step S8100. Then, the data processing unit 115 starts checking the vertical relevance again in the hierarchical layer that is higher by one level than the hierarchical layer on which the grouping has been performed the last time. Subsequently, the processing performed in steps S8100 to S8110 is repeatedly performed.

In the case of the example shown in FIGS. 21A and 21B, a division width (that is, the horizontal grouping length) is equal to the page width. Thus, the data processing unit 115 finishes the processing. Finally, the data processing unit 115 adds the highest hierarchical layer V0, which corresponds to the entire page, to the document structure tree. Then, the data processing unit 115 finishes the document structure tree generation process illustrated in FIG. 20.

The processing performed in step S8004 shown in FIG. 19 is more specifically described with reference to FIGS. 21A and 21B. Because the group H1 has the two blocks T1 and T2 arranged in a horizontal direction, the data processing unit 115 outputs the group H1 as two columns. That is, the data processing unit 115 refers to the DAOF data and first outputs internal information on the block T1 (that is, information representing texts obtained by the character recognition and also representing images).

Subsequently, the data processing unit 115 changes a processing object to the other column. Similarly, then, the data processing unit 115 outputs internal information on the block T2. Subsequently, the data processing unit 115 outputs the separator S1. Because the group H2 has the two groups V1 and V2 arranged in a horizontal direction, the data processing unit 115 first outputs the group H2 as two columns. The data processing unit 115 outputs the group V1, that is, outputs pieces of information, which respectively correspond to the blocks T3, T4, and T5, in this order. Then, the data processing unit 115 changes a processing object to the other column. Subsequently, the data processing unit 115 outputs the group V2, that is, pieces of internal information, which respectively correspond to the block T6 and T7, in this order.

Thus, as described above, the present embodiment enables effective reutilization of print data stored upon printing. Also, the present embodiment can enhance quality of information on security by storing data representing a reprint history table in the internal memory of the MFP 100, as shown in FIG. 7.

Image Area Discrimination Using Attribute to Each Print Object Represented by Print Data

The block selection processing in step S122 shown in FIG. 3 may erroneously determine an attribute according to raster image data to be processed. When the attribute is erroneously determined, the subsequent vectorization processing may be inappropriate. Hereinafter, a method of correctly discriminating the attribute of a raster image, instead of the block selection processing in step S122, is described.

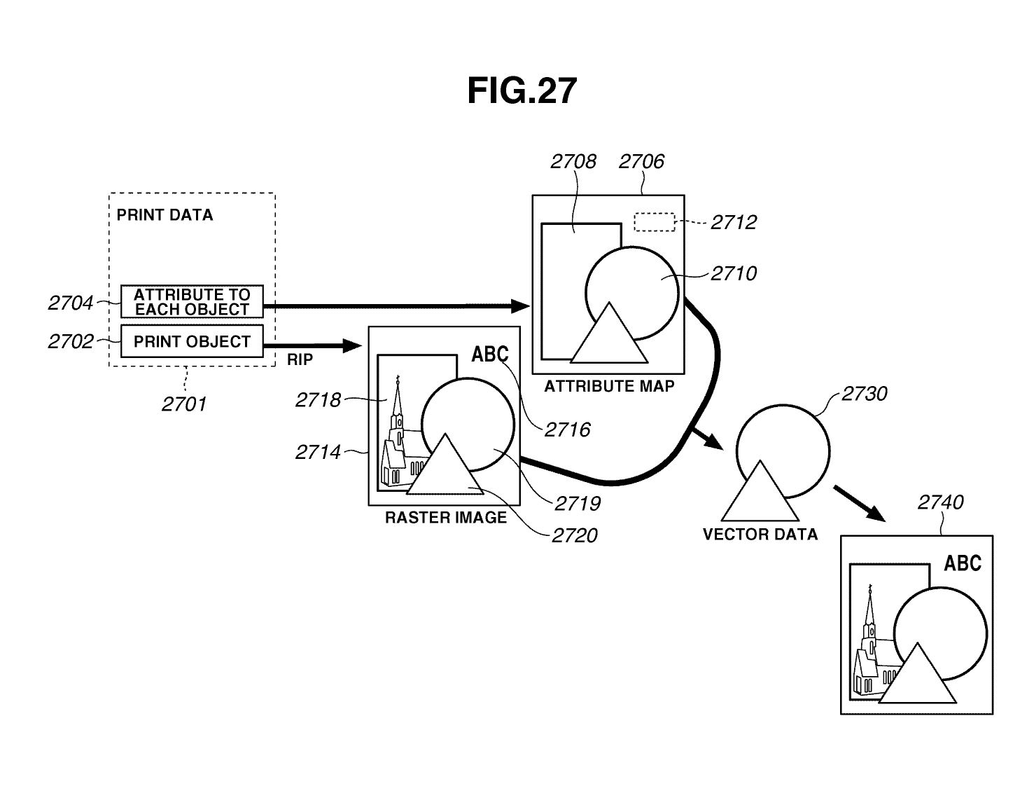

FIG. 27 illustrates a process for vectorizing raster image data using an attribute map, which will be described later.

Print data 2701 transmitted from the client PC 102 to the MFP 100 is assumed to be expressed in page description language (PDL). The print data 2701 expressed in PDL includes information on a location, at which an image, a text, or a graphic to be printed (hereunder referred to generically as a “print object” 2702) is printed, in a page. Also, the print data 2701 includes information on an image attribute 2704 of each of the print objects 2702 (that is, information 2704 representing an attribute to each object).

The data processing unit 115 generates an attribute map 2706 according to the information 2704 representing an attribute to each object when the print data is converted into raster image data 2714.

The attribute map is a kind of bit map data corresponding to the raster image data 2714. Each of pixels representing the attribute map indicates a flag representing an attribute of an image. The attribute of an image, which is represented by the flag, is based on information 2704 representing the attribute to each object, which is included in the print data 2701.

In the example shown in FIG. 27, among print objects represented by the raster image data 2714, the attributes of a print object 2716, a print object 2718, and print objects 2719 and 2720 are respectively specified by the information 2704, which represents an object to each object, to be a “text” attribute, a “photo” attribute, and a “graphics” attribute. Therefore, an attribute map 2706 indicates that an image area 2710 (including both of a circular graphic and a triangular graphic) is a bit map which includes a flag representing a “graphics” attribute, that an image area 2712 is a bit map which includes a flag representing a “text” attribute, and that an image area 2708 is a bit map which includes a flag representing a “photo” attribute.

The attribute map is essentially generated to perform appropriate image processing corresponding to each kind of an object when print data is converted to raster image data. Therefore, a conventional image processing apparatus deletes an attribute map because the attribute map is not used after raster image data is generated. However, the present embodiment is adapted to store the attribute map 2706 in the storage unit 111 together with the raster image data 2714, and to also utilize the attribute map 2706 in a case where the vectorization processing, especially, image area discrimination processing, is performed later.

Thus, the image area map 2706 is also utilized at the vectorization, so that the block selection processing in step S122 is not performed. Consequently, time required to perform the vectorization processing can be shortened by a length of time required for the block selection processing. Additionally, no erroneous determination of the attribute occurs during the block selection processing. Consequently, more accurate attribute discrimination is enabled.

Although an example of expressing the print data 2701 in PDL has been described in the foregoing description, the print data 2701 of another format may be used. For example, the print data may be data obtained by adding data, which corresponds to the attribute map 2706, to raster image data, into which print data is preliminarily rasterized by the client PC. In this case, it is sufficient to store the print data, to which the data corresponding to the attribute map is added, in the storage unit 111.

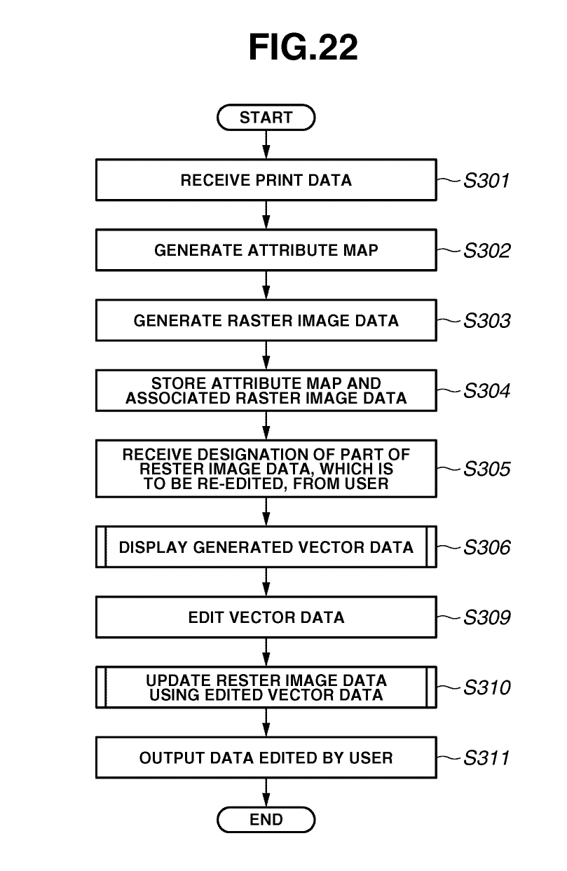

Hereinafter, vectorization processing using the attribute map 2706 created according to information 2704 representing the attribute to each print object, which is represented by the print data 2701, is described with reference to FIGS. 22 and 27.

FIG. 22 is a flowchart illustrating an example of a process for extracting, changing and reflection processing on vector data, which is performed by the MFP 100. The process illustrated in this flowchart is performed under the control of the data processing unit 115 of the MFP 100.

In step S301, the data processing unit 115 receives the print data 2701 transmitted from the client PC 102 through the network interface 114.

In step S302, the data processing unit 115 creates an attribute map 2706, which is used to appropriately perform image processing on objects having each of the attributes (for example, a photo attribute, a graphic attribute, and a text attribute), from the print data. The “graphic” includes pictures. The “photo” includes photos.

In step S303, the data processing unit 115 rasterizes the print data received in step S301. Then, the data processing unit 115 generates raster image data 2714 by using the attribute map 2706 created in step S302, while performing appropriate image processing on each print object.

In each of steps S302 and S303, a part of the processing may be performed in parallel to another part thereof.

In step S304, the data processing unit 115 causes the storage unit 111 to store the raster image data 2714 generated in step S303 and the attribute map 2706 created in step S302 by associating the raster image data 2714 with the attribute map 2706. The storage location, at which the raster image data 2714 and the attribute map 2706 are stored, may be the document management server 104.

In step S305, the data processing unit 115 receives an instruction designating a part of the raster image data 2714, which is to be re-edited, from a user through the user interface unit 116. A method of designating an area to be vectorized is to display the raster image data 2714 in the user interface unit 116 and to then set the area, which is to be vectorized, at an area having an attribute corresponding to the part designated by a user from the touch panel. Alternatively, the area to be vectorized may be performed as follows. That is, buttons “PHOTO”, “GRAPHICS”, and “TEXT” are displayed on the touch panel of the user interface unit 116. Then, the area to be vectorized is set at an area having an attribute corresponding to the button depressed by a user. According to the process illustrated by this flowchart, it is assumed that after an image of a graphic part in the print data is re-edited by way of example, the data processing unit 115 receives a request for re-outputting the image data. Alternatively, the area to be vectorized may be set at an area other than an area having an attribute corresponding to the button depressed by a user. Alternatively, a plurality of areas to be vectorized may be set. The image processing apparatus may be adapted so that unless otherwise noted, the entire raster image data 2714 is set to be vectorized.

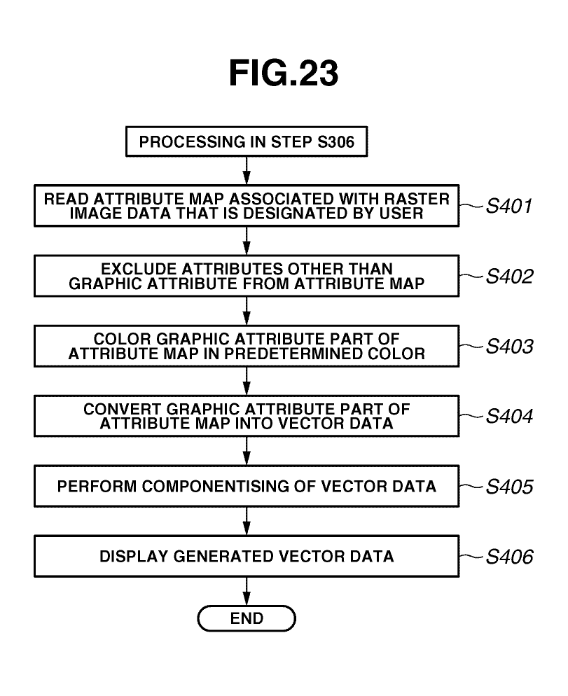

In step S306, the data processing unit 115 extracts an area 2710 having a graphic attribute from the attribute map 2706 stored by being associated with the raster image data 2714, the re-output of which is requested by a user. Then, the data processing unit 115 generated vector data according to data representing a graphic of the graphic attribute, which is extracted from the attribute map. Subsequently, the data processing unit 115 causes the display unit 116 to display the generated vector data to present the vector data to a user. Processing performed in step S306 is described in detail with reference to FIG. 23.

In an indication displayed in step S306, the componentisation of the vector data has already been completed. Thus, a user can edit the vector data in the user interface unit 116.

In step S309, the data processing unit 115 edits the vector data in response to an edit operation performed by a user using the user interface unit 116.

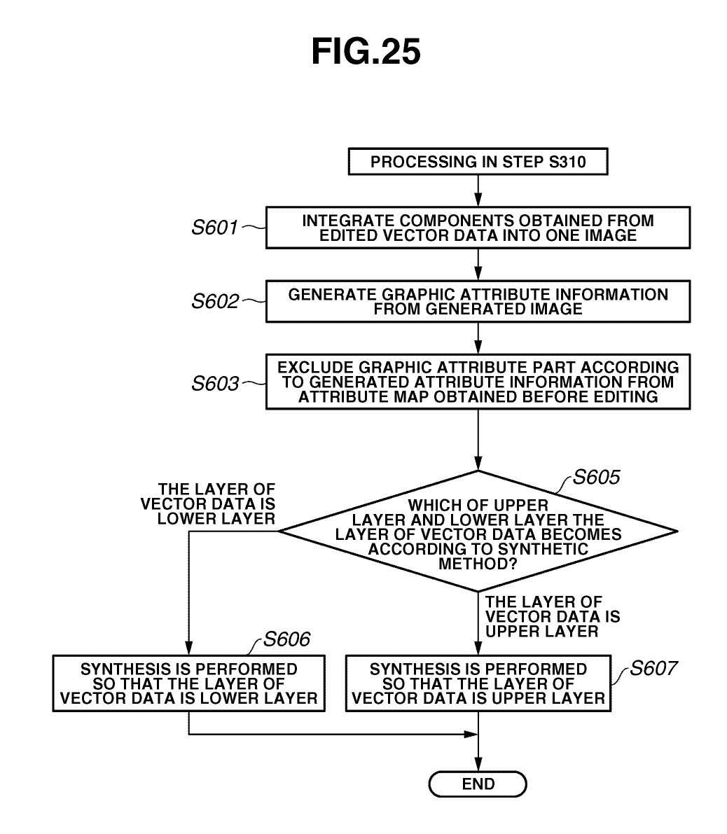

In step S310, the data processing unit 115 updates the raster image data 2714 by using the edited vector data. Processing performed in step S310 is described in detail later by referring to FIG. 25.

In step S311, the data processing unit 115 outputs the raster image data 2714, on which the reflection processing has been performed, to the recording paper using the recording unit 112.

FIG. 23 is a flowchart illustrating an example of a vector data generation process for generating vector data from the attribute map 2706. Hereinafter, the process illustrated in this flowchart is described by also referring to FIG. 27.

In step S401, the data processing unit 115 reads the attribute map 2706, which is stored by being associated with the raster image data 2714 designated by a user, from the storage unit 111.

In step S402, the data processing unit 115 excludes attributes other than the graphic attribute 2710 from the read attribute map 2706.

In step S403, the data processing unit 115 colors the part, which has the graphic attribute, with a preliminarily set color in the attribute map. The processing in step S403 is not necessarily performed in this stage, and may be performed in edit processing in step S309.

In step S404, the data processing unit 115 converts the part having the graphic attribute in the attribute map to vector data. The data processing unit 115 converts the part having the graphic attribute to vector data according to the method illustrated in FIGS. 10 to 13D.

In particular, in a case where a user issues an instruction in step S305 to perform vectorization, without designating a specific area, the entire raster image data is set in step S404 as an area to be vectorized. In this case, an image attribute is discriminated using the attribute map 2706, without performing the block selection processing to discriminate the image attribute, and subsequently, vectorization processing is performed according to the discriminated image attribute.

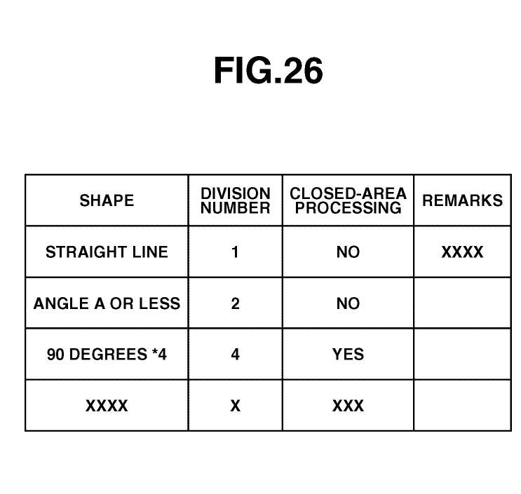

In step S405, the data processing unit 115 performs sectionalization and componentization on vector data in the attribute map based on a straight line/a curved line according to rules represented by a user-specified information table such as the one shown in FIG. 26. The componentization processing will be described later in detail.

In step S406, the data processing unit 115 displays the vector data, which is generated in step S404, on the user interface unit 116.

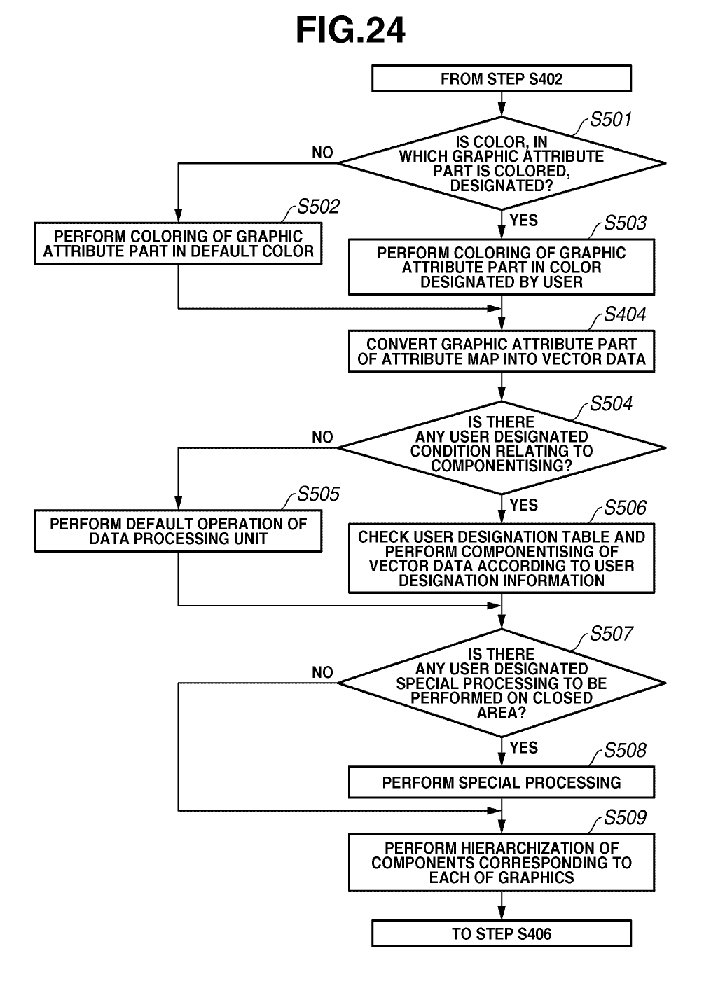

FIG. 24 shows in detail the processing performed in steps S403 to S405 shown in FIG. 23. FIG. 24 is a flowchart illustrating an example of a process for vectorization and componentisation.

In step S501, the data processing unit 115 determines whether a user designates a color with which the part having the graphic attribute is colored. For example, according to whether information on the user's designated color is stored in the internal memory, the data processing unit 115 determines whether the color is designated.

If the data processing unit 115 determines that a user designates the color with which the part having the graphic attribute is colored, the process proceeds to step S503. If the data processing unit 115 determines that the user has not designated the color with which the part having the graphic attribute is colored, the process proceeds to step S502.

In step S502, the data processing unit 115 colors the part having the graphic attribute with a color (for example, black) set by default. On the other hand, in step S503, the data processing unit 115 colors the part having the graphic attribute with a color represented by the user-specified color information.

Processing in step S404 shown in FIG. 24 is similar to that in step S404 shown in FIG. 23.

In step S504, the data processing unit 115 determines whether information on the componentisation of vector data is specified by a user. For example, the data processing unit 115 determines whether a user-specified information table shown in FIG. 26, in which user-specified information on the componentisation is registered, is stored in the internal memory.

If the data processing unit 115 determines that the information on the componentisation of vector data is specified by the user, the process proceeds to step S506. If the data processing unit 115 determines that the information on the componentisation of vector data is not specified by a user, the process proceeds to step S505.

In step S505, the data processing unit 115 performs default componentisation processing, for example, componentisation of all of straight lines. On the other hand, in step S506, the data processing unit 115 refers to, for example, the user-specified information table stored in the internal memory, and performs the componentisation of the vector data according to the user-specified data information on the componentisation. FIG. 26 shows an example of the user-specified information table, which will be described later.

In step S507, the data processing unit 115 determines whether an instruction to perform special processing on a closed area in an image represented by the vector data is issued by a user. For example, according to whether information on an instruction to perform special processing on a closed area in an image represented by the vector data is stored in the internal memory, the data processing unit 115 determines whether an instruction to perform special processing on a closed area in an image represented by the vector data is issued by a user. The information on an instruction to perform special processing on a closed area is, for example, information on an instruction to color the inside of the closed area with a specific color.

If the data processing unit 115 determines that an instruction to perform special processing on a closed area in an image represented by the vector data is issued by a user, the process proceeds to step S508. Otherwise, if the data processing unit 115 determines that an instruction to perform special processing on a closed area in an image represented by the vector data is not issued by a user, the special processing is not performed. Then, the process proceeds to step S509.

In step S508, the data processing unit 115 performs the special processing, for example, an operation of individually componentising straight lines defining the closed area, according to the information on the instruction to perform the special processing on the closed area in the image represented by the vector data, which is stored in, for instance, the internal memory.

In step S509, the graphics componentized in steps S505 and S506 and the components, to which an instruction to perform the special processing on a closed area is issued, are hierarchized corresponding to each of the graphics. Subsequently, the process proceeds to step S406.

FIG. 25 is a flowchart illustrating an example of an edited vector data replacement process (performed in step S310 shown in FIG. 22). In step S601, the data processing unit 115 integrates components represented by edited vector data to generate a single image. The vector data 2730 shown in FIG. 27 is obtained by integrating the components. In step S602, the data processing unit 115 generates graphic attribute information from an image generated in step S601. According to the present embodiment, an area having a graphic attribute is vectorized according to the attribute map 2706. Thus, the attribute information generated in step S602 corresponds to the graphic attribute. However, in a case where an image in the area having the graphic attribute includes a character, and where this character is recognized as a character by performing character recognition processing while the vectorization processing is performed, it is reasonable to treat the area as a text area. That is, in such a case, image area information, which indicates that a text area is present in a graphic area, is generated. Also, in a case where a user designates an area other than an area having a graphic attribute in step S305, the attribute information corresponding to the attribute of the designated area is generated in step S602.

In step S603, the data processing unit 115 removes the part having the graphic attribute from the attribute map 2706 stored by being associated with the raster image data 2714, which is designated by a user as an object to be edited, before being edited. Then, the data processing unit 115 generates an attribute map by excluding the part having the graphic attribute. In a case where a user designates an area other than the area having the graphic attribute in step S305 shown in FIG. 22, the data processing unit 115 excludes the area having the designated attribute.

In step S605, the data processing unit 115 determines a method of synthesizing data from the vector data 2730, which is obtained by integrating the components in step S601, and the original raster image data 2714. In the present embodiment, the raster image data 2714 and the vector data 2730 obtained by integrating the components are treated as different layers. Also, in step S605, as a synthesis method, the data processing unit 115 determines which of the layers is set to be a higher layer.

If the data processing unit 115 determines in step S605 that data synthesis is performed by setting the vector data 2730 to be an upper layer, the process proceeds to step S607. If the data processing unit 115 determines in step S605 that data synthesis is performed by setting the vector data 2730 to be a lower layer, the process proceeds to step S606.

In step S606, the data processing unit 115 performs the synthesis by setting the vector data 2730 to be a lower layer than a layer corresponding to the raster image data 2714. Also, the data processing unit 115 generates a new attribute map by combining the attribute information generated in step S602 with the attribute information that is generated in step S603 by removing the graphic area. In this case, the attribute maps are combined with each other so that the vector data 2730 is a lower layer compared to a layer corresponding to the raster image data 2714.

On the other hand, in step S607, the data processing unit 115 performs the synthesis so that the vector data 2730 is an upper layer than a layer corresponding to the raster image data 2714. Also, a new attribute map is generated by combining the attribute information generated in step S602 with the attribute information generated in step S603 by removing the graphic area. In this case, the attribute maps are combined with each other so that the vector data 2730 is an upper layer compared to a layer corresponding to the raster image data 2714.

An image 2740 shown in FIG. 27 is obtained as a result of performing the synthesis between the vector data 2730 and the raster image data 2714. This image 2740 is obtained as an example in a case where the synthesis is performed so that the graphic area is an upper layer.

Componentisation of Vector Data

FIG. 26 illustrates an example of a user-specified information table relating to the componentisation of vector data, which is performed in step S405 shown in FIG. 23. As shown in FIG. 26, the user-specified information table includes the shape of an image represented by vector data, the division number by which the image is divided into straight lines, and the closed-area processing to be performed on the image, as items therein. That is, a user can set the number of straight lines, into which the image represented by the vector data is divided, and also can set whether the closed-area processing is performed on the image.

The item “shape” has a field named “Angle A or less” representing a value of an angle formed at a junction of straight lines. In this case, the angle may include an interior angle and an exterior angle. However, a user can optionally set which of an interior angle or an exterior angle the angle formed at the junction is. In the example shown in FIG. 26, regardless of whether the angle formed at the junction is an interior angle or an exterior angle, the “division number” is set at 2 in a case where the value of the angle formed at the intersection of two straight lines is less than the angle A. That is, the two straight lines, between which the angle, whose value is equal to or less than the angle A, is formed, are set to correspond to different vectors, respectively. Conversely, the two straight lines forming an angle, whose value is larger than the angle A, are componentised to be one vector data element. That is, the two straight lines are treated as one piecewise line. Additionally, the item “shape” has a field named “90 degrees *4” that designates a closed area shaped into a square or a rectangle.

As described above, according to the present embodiment, accurate vector data can be extracted from the attribute map (or attribute information) of objects, which is stored together with the print data. Also, according to the present embodiment, the extracted vector data can be edited or reutilized. Although the present embodiment has been described by employing graphics as an example of the attribute of objects to be processed, processing similar to that according to the present embodiment can be performed on images or text. Thus, the present embodiment can provide technology relating to effective reutilization of print data having once been printed or stored.

### Other Embodiments

The present invention may be applied to either a system including a plurality of devices (for example, a host computer, an interface device, a reader, and a printer) or an apparatus constituted by a single device (for example, a copier, a facsimile apparatus).

The present invention can be implemented by providing a storage medium (or recording medium) storing software program code for performing the functions of the above exemplary embodiment to a system or an apparatus, and subsequently executing the program by the system or the apparatus. In this case, software itself read from the storage medium realizes the functions of the exemplary embodiments. The storage medium storing the program code constitutes the present invention.

In addition of the case of implementing the functions by executing the software, the present invention includes a case where an operating system (OS) running on the computer performs a part or all of actual processes according to instructions from the software and implements the above functions.

The present invention also includes a case where the software is written to a memory provided in a function expansion card or unit connected to the computer, and where a CPU provided in the function expansion card or unit performs a part or all of a process according to the instructions from the software and implements the functions of the above exemplary embodiments.

In a case where the present invention is applied to the storage medium, software corresponding to the above-described flowcharts is stored in the storage medium.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2005-355138 filed Dec. 8, 2005, which is hereby incorporated by reference herein in its entirety.

What is claimed is:

1. An image processing apparatus comprising:
a receiving unit configured to externally receive print data including information on an attribute of an image to print;
a rasterizing unit configured to generate raster image data based on the print data received by the receiving unit;
an attribute data generating unit configured to generate attribute data representing an attribute of an image included in the raster image data generated by the rasterizing unit based on the information on an attribute of an image to print included in the print data; and
a vectorizing unit configured to vectorize at least a part of the raster image data,
wherein the vectorizing unit identifies the attribute of the image included in the raster image data based on the attribute data generated by the attribute data generating unit, and performs vectorization processing based on the identified attribute of the image.

2. The image processing apparatus according to claim 1, further comprising a storage unit configured to store the raster image data generated by the rasterizing unit and the attribute data generated by the attribute data generating unit and associate the raster image data with the attribute data,
wherein the vectorizing unit vectorizes the raster image data stored on the storage unit based on the associated attribute data stored on the storage unit.

3. The image processing apparatus according to claim 2, further comprising an image forming unit configured to form an image based on the raster image data,
wherein the storage unit stores the raster image data and the attribute data and associates the raster image data with the attribute data even after the image forming unit forms an image based on the raster image data.

4. The image forming apparatus according to claim 2, further comprising an updating unit configured to update the attribute data stored and associated with the raster image data based on an attribute of an image included in vector data obtained by the vectorizing unit vectorizing the raster image data.

5. The image processing apparatus according to claim 1, further comprising:
a storage control unit configured to cause an external storage unit to store the raster image data and the attribute data and associate the raster image data with the attribute data; and
an image forming unit configured to form an image based on the raster image data,
wherein after the image forming unit forms an image based on the raster image data, the storage control unit causes the external storage unit to store the raster image data and the attribute data and associate the raster image data with the attribute data.

6. The image processing apparatus according to claim 5, wherein the vectorizing unit vectorizes the raster image data stored on the external storage unit based on the associated attribute data stored on the external storage unit.

7. The image forming apparatus according to claim 1, further comprising an editing unit configured to edit vector data obtained by the vectorizing unit vectorizing the raster image data.

8. The image processing apparatus according to claim 1, wherein types of attributes of images represented by the attribute data include at least one of a text attribute, a photo attribute, and a graphics attribute.

9. An image processing apparatus comprising:
a receiving unit configured to externally receive print data including information on an attribute of an image to print;
a rasterizing unit configured to generate raster image data based on the print data received by the receiving unit;
an attribute data generating unit configured to generate attribute data representing an attribute of an image included in the raster image data generated by the rasterizing unit based on the information on an attribute of an image to print included in the print data;
a vectorizing unit configured to vectorize at least a part of the raster image data; and
an area determining unit configured to determine an area to be vectorized by the vectorizing unit in the raster image data according to an instruction from a user,
wherein the vectorizing unit identifies the attribute of the image in the area determined by the area determining unit based on the attribute data generated by the attribute data generating unit, and performs vectorization on the area in the raster image data based on the identified attribute of the image.

10. The image processing apparatus according to claim 9, further comprising a synthesis unit configured to synthesize the raster image data and vector data obtained by the vectorizing unit performing vectorization on the area in the raster image data.

11. An image processing method comprising:
externally receiving print data including information on an attribute of an image to print;
generating raster image data based on the received print data;
generating attribute data representing an attribute of an image included in the generated raster image data based on the information on an attribute of an image to print included in the print data; and
vectorizing at least a part of the raster image data,
wherein the vectorizing includes identifying the attribute of the image included in the raster image data based on the generated attribute data, and performing vectorization based on the identified attribute of the image.

12. An image processing method comprising:
externally receiving print data including information on an attribute of an image to print;
generating raster image data based on the received print data;
generating attribute data representing the attribute of the image included in the generated raster image data based on the information on an attribute of an image to print included in the print data;
vectorizing at least a part of the raster image data; and
determining an area to be vectorized in the raster image data according to an instruction from a user,
wherein the vectorizing includes identifying the attribute of the image in the determined area based on the generated attribute data, and performing vectorization on the area in the raster image data based on the identified attribute of the image.

13. A storage medium adapted to store a control program for causing an image processing apparatus to perform an image processing method, the control program comprising:
externally receiving print data including information on an attribute of an image to print;
generating raster image data based on the received print data;
generating attribute data representing an attribute of an image included in the generated raster image data based on the information on an attribute of an image to print included in the print data; and
vectorizing at least a part of the raster image data,
wherein the vectorizing includes identifying the attribute of the image included in the raster image data based on the generated attribute data, and performing vectorization based on the identified attribute of the image.

14. A storage medium adapted to store a control program for causing an image processing apparatus to perform an image processing method, the control program comprising:
externally receiving print data including information on an attribute of an image to print;
generating raster image data based on the received print data;
generating attribute data representing the attribute of the image included in the generated raster image data based on the information on an attribute of an image to print included in the print data;
vectorizing at least a part of the raster image data; and
determining an area to be vectorized in the raster image data according to an instruction from a user,
wherein the vectorizing includes identifying the attribute of the image in the determined area based on the generated attribute data, and performing vectorization on the area in the raster image data based on the identified attribute of the image.

15. An image processing apparatus comprising:
a receiving unit configured to externally receive print data;
a rasterizing unit configured to generate raster image data based on the print data received by the receiving unit;
an attribute data generating unit configured to generate attribute data representing an attribute of an image included in the raster image data; and
a vectorizing unit configured to vectorize at least a part of the raster image data,
wherein the vectorizing unit identifies the attribute of the image included in the raster image data based on the attribute data generated by the attribute data generating unit, and performs vectorization processing based on the identified attribute of the image.
